(19) United States
(12) Patent Application Publication
(10) Pub. No.: US 2024/0241432 A1
(43) Pub. Date: Jul. 18, 2024

(54) PREFINISHED CURVILINEAR MAGNETIC SCREEN SYSTEM

(71) Applicant: FG HOLDINGS GROUP INC., CHARLOTTE, NC (US)

(72) Inventor: Dustin SMALL, Kissimmee, FL (US)

(21) Appl. No.: 18/413,754

(22) Filed: Jan. 16, 2024

Related U.S. Application Data
(60) Provisional application No. 63/438,880, filed on Jan. 13, 2023.

(51) Int. Cl. G03B 21/14; G03B 21/56

(52) U.S. Cl. CPC G03B 21/145; G03B 21/56

(57) ABSTRACT

A prefinished curvilinear magnetic screen system comprising a curvilinear structural frame and a plurality of screen panels adjustably secured to the curvilinear structural frame using magnetic forces. The system also includes an optical coating over the screen panels to define a curvilinear projection surface and the edges of the screen panels include interlocking tongue and groove joints. In addition, the screen panels have a plurality of magnets embedded proximate edges of the plurality of screen panels and are configured to assist in adjusting a respective position of each of the plurality of panels to the curvilinear structural frame. The curvilinear structural frame comprises a plurality of pipe trusses and a plurality of flat bars that are supported by the plurality of pipe trusses, and the screen panels are secured to the flat bars. The system also includes optical seaming tape or optical caulk over joints between the screen panels.

### CROSS-REFERENCE TO RELATED APPLICATIONS

This application claims the benefit of U.S. provisional application No. 63/438,880 filed Jan. 13, 2023, which is hereby incorporated herein in its entirety by reference.

### TECHNICAL FIELD

The present invention relates to the field of curvilinear projection screens, and, more particularly, to a prefinished curvilinear magnetic screen system.

### BACKGROUND

Immersive screen systems have a curvilinear surface and are installed all over the world. The immersive screen systems generally include structural framework and curvilinear screen panels which are mounted to the framework. The joints between each of the screen panels must be filled and sanded smooth after they are mounted to the framework to create a seamless surface. An optical coating can then be applied over the surface.

The finishing process of a seamless curvilinear projection screen requires specialized gear such as custom HVLP spray rigs, high reach rental equipment, air compressors, sanding equipment, temporary spray tent, air filtration/scrubbers, PPE gear, and specialty trained workers, which the lengthy process drives up the cost of an immersive screen system.

Accordingly, what is needed in the art is a curvilinear projection screen that is quick and easy to install with similar projection performance as a seamless screen system. Reducing the need for special equipment and extensive finishing labor reduces the overall cost significantly.

### SUMMARY

In view of the foregoing background, it is therefore an object of the present invention to provide a curvilinear projection screen that is high quality while being easy to install and cost effective. This and other objects, features, and advantages in accordance with the present invention are provided by a prefinished curvilinear magnetic screen system comprising a curvilinear structural frame having a front side and a rear side, a plurality of screen panels adjustably secured to the front side of the curvilinear structural frame using magnetic forces, and an optical coating over the plurality of screen panels to define a curvilinear projection surface. The edges of the plurality of screen panels may include interlocking tongue and groove joints. In addition, the plurality of screen panels may have a plurality of magnets embedded proximate edges of the plurality of screen panels and configured to assist in adjusting a respective position of each of the plurality of panels to the curvilinear structural frame.

The curvilinear structural frame may comprise a plurality of pipe trusses and a plurality of flat bars that are supported by the plurality of pipe trusses, where the plurality of screen panels are secured to the flat bars. The system may also include a plurality of pipe brackets that each comprise a first portion and a second portion and that are configured to clamp around a pipe of the pipe trusses and connect to a respective flat bar. Optical seaming tape or optical caulk may be used over joints between the plurality of screen panels to create a smooth surface without noticeable interruption.

In another aspect, method of fabricating a prefinished curvilinear magnetic screen system is disclosed. The method includes erecting a curvilinear structural frame having a front side and a rear side, and positioning a plurality of screen panels on to the front side of the curvilinear structural frame. The plurality of screen panels are adjustably secured to the curvilinear structural frame using magnetic forces. The method also includes adjusting the plurality of screen panels on the curvilinear structural frame to tighten joints between the plurality of screen panels. The plurality of screen panels may have a plurality of magnets embedded in the proximate edges of the screen panel. In addition, the method may include securing the plurality of panels to the curvilinear structural frame using mechanical fasteners to prevent the plurality of panels from moving, and applying an optical caulking or an optical seaming tape over vertical and horizontal joints between the plurality of screen panels. The method may include joining edges of the plurality of screen panels together using interlocking tongue and groove joints.

The curvilinear structural frame may comprise a plurality of pipe trusses and a plurality of flat bars that are supported by the plurality of pipe trusses and the plurality of screen panels are secured to the flat bars. The plurality of screen panels may comprise thermoformable material or other similar lightweight material.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a front perspective view of a prefinished curvilinear magnetic screen system in accordance with the present disclosure;

FIG. 2 is a rear perspective view of the prefinished curvilinear magnetic screen system shown in FIG. 1;

FIG. 3 is a front perspective view of the GRG surface panels being installed on the corvilinear structural frame;

FIG. 4 is an exploded view of the prefinished curvilinear magnetic screen system;

FIG. 5 is a right side elevational view of the prefinished curvilinear magnetic screen system;

FIG. 6 is an elevational detail view of connectors the prefinished curvilinear magnetic screen system;

FIG. 7 is a front view of a screen panel of the prefinished curvilinear magnetic screen system;

FIG. 8 is a rear view of the screen panel shown in FIG. 7;

FIG. 9 is an exploded cross sectional detail view of a screen panel connection;

FIG. 10A is an exploded elevational detail view of the screen panel connection of FIG. 9;

FIG. 10B is a plan view of a flat bar oversized washer;

FIG. 11 is an elevational detail view of the screen panel connection of FIG. 10 connected to a curvilinear structural frame;

FIG. 12 is an exploded cross sectional detail view of a connection of magnets secured to the screen panel;

FIG. 13 is an exploded elevational detail view of the connection of the magnets of FIG. 12;

FIG. 14 is an elevational detail view of the connection of the magnets of FIG. 13 secured to the screen panel;

FIG. 15A is a cross sectional top detail view of a rolled pipe bracket connected to a rolled pipe of the curvilinear structural frame;

FIG. 158 is a cross sectional elevational detail view of the rolled pipe bracket of FIG. 15A;

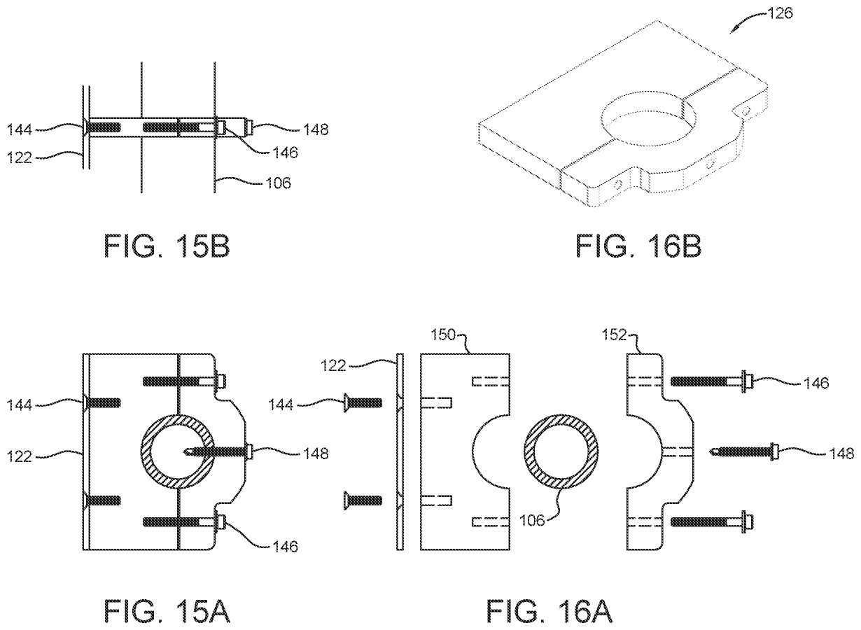

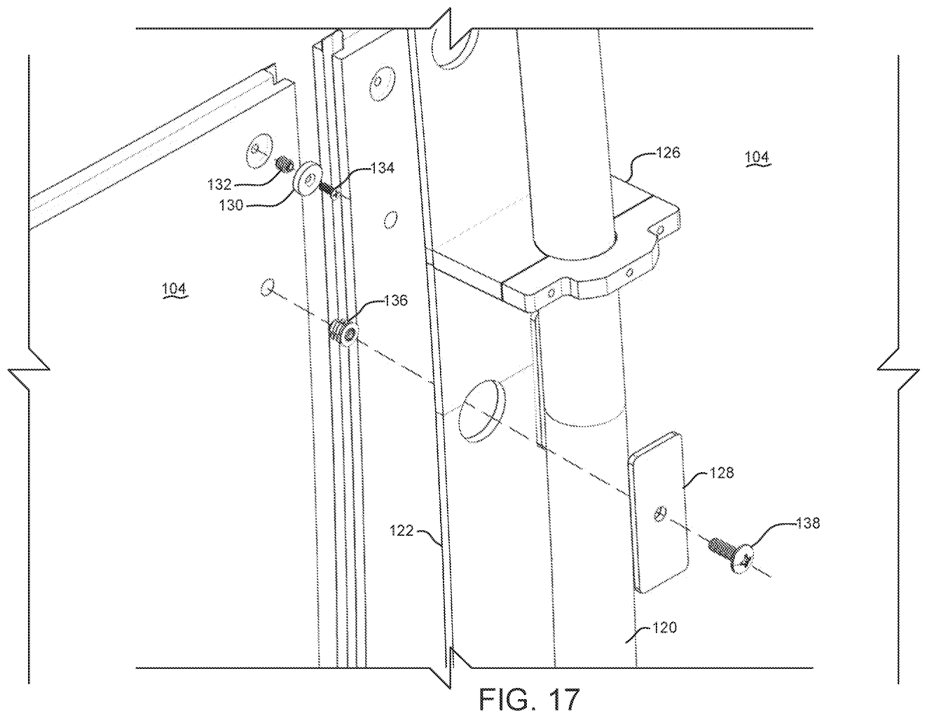

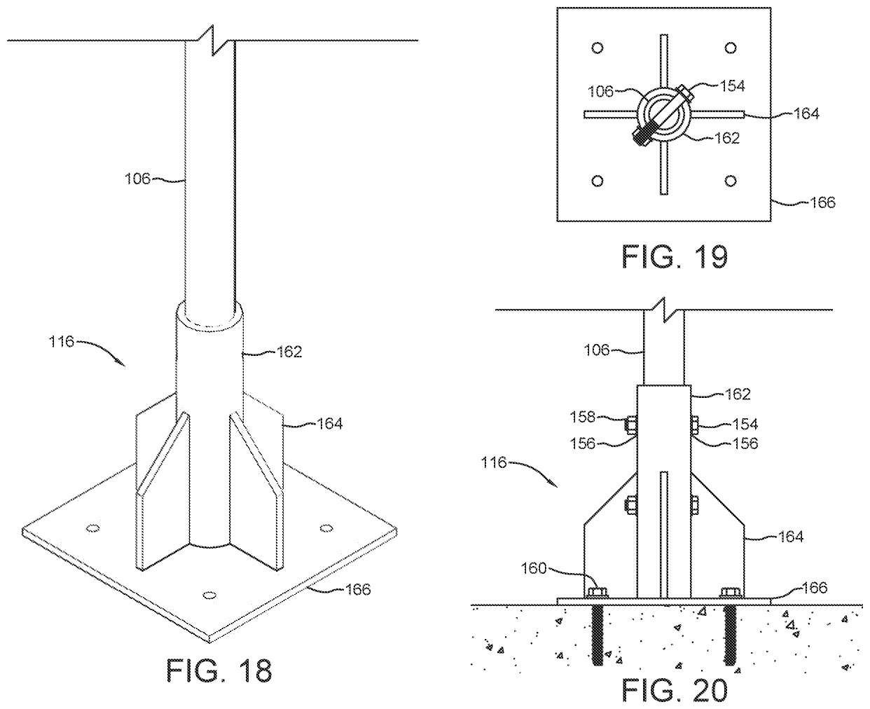

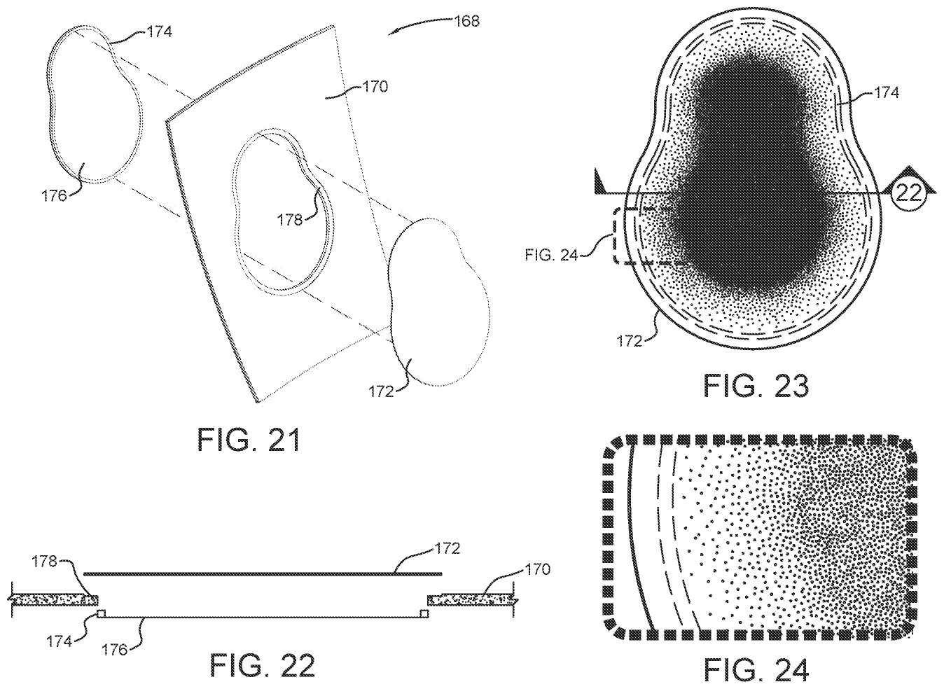

FIG. 16A is an exploded cross sectional detail view of the rolled pipe bracket of FIG. 15A;

FIG. 16B is a perspective view of the rolled pipe bracket of FIG. 16A;

FIG. 17 is an exploded perspective detail view of the connection of the screen panel to a flat bar of the curvilinear structural frame;

FIG. 18 is a perspective view of a base of the curvilinear structural frame;

FIG. 19 is a plan view of the base of FIG. 18;

FIG. 20 is an elevational view of the base of FIG. 18;

FIG. 21 is an exploded view of an acoustic panel of the prefinished curvilinear magnetic screen system;

FIG. 22 is a cross sectional view of the acoustic panel taken in the direction of line 22 of FIG. 23;

FIG. 23 is a plan view of the acoustic panel of FIG. 21; and

FIG. 24 is a detail view of a portion of the acoustic panel.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A prefinished curvilinear magnetic screen system of the present invention includes welded tubular structural frame also referred to as a screen truss, prefinished screen panels, optical seaming tape and/or optical caulking between joints of the screen panels, and a projection coating on the screen panels. The present system creates an almost seamless projection surface with relatively minimal installation labor. In addition, there are no fumes from the projection coating during installation because the coating is applied at the factory before shipping. Moreover, an acoustic panel can be used with the present system, which is disclosed in commonly assigned U.S. Pat. No. 9,664,994, and the disclosure of which is hereby incorporated by reference in its entirety.

After the structural frame is erected on-site by the installation technicians, the screen panels are ready to be assembled. The screen panels are lightweight and prefinished with the projection coating. The screen panels also have magnets embedded on a rear surface as explained in more detail below. The installation technician places a respective screen panel to the structural framework and magnetic forces hold the respective screen panel in place. The process is repeated until the entire screen surface is complete. The time needed for installation on-site is reduced to a few days.

Also, the screen panels can be adjusted on the structural framework to the left, right, up, and down by tapping on an edge of the respective screen panel with a mallet because magnetic forces allow some movement. Accordingly, joints between the screen panels may be tightened and adjusted anytime during the installation process with minimal gaps. A minimal gap between the screen panels is critical for optimal visual performance.

Once all the screen panels are positioned and adjusted on the structural frame to form the screen surface, the screen panels can be secured using mechanical fasteners or other similar devices for permanently securing the screen panels in place. The mechanical fasteners keep the seams and joints between the screen panels tight and prevent movement over time. An optical caulking or an optical seaming tape is applied over the vertical and horizontal joints between the screen panels. Both the screen panels and the optical seaming cape are prefinished with a matching projection coating (i.e., optical screen paint). The optical seaming tape of the optical caulking hide the joints between the screen panels and make them undetectable when media is projected on the screen surface.

The optical seaming tape may comprise of thin stainless-steel strips that are approximately 1 inch wide and approximately by 5 thousand the thick. The face of the seaming tape includes prefinished projection coating, while the backside may be coated with an adhesive. The optical seaming tape may be applied while the installation technicians are wearing gloves to ensure no fingerprints or residue is left during installation. The installation technicians may apply the optical seaming tape with a soft rubber or foam roller to press the adhesive over the vertical and horizontal screen panel joints. The optical caulking is a proprietary caulking that matches the optical properties of the projection coating. The optical caulking may be applied in the joints using a caulking gun, for example, and wiped clean over the screen panel joints to make the joints virtually undetectable.

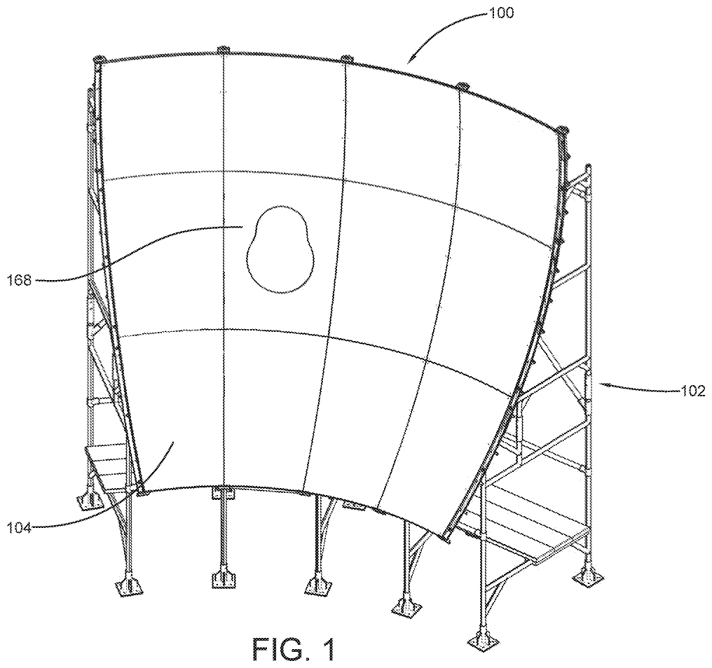

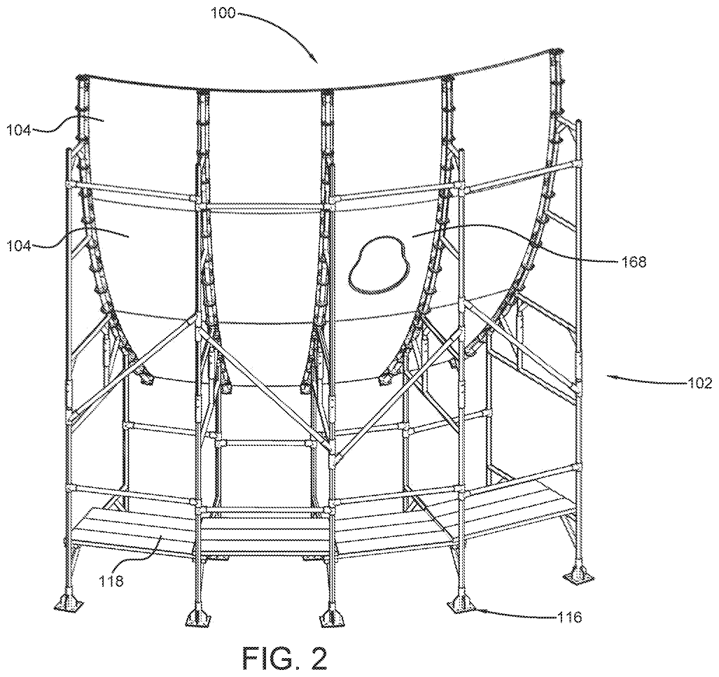

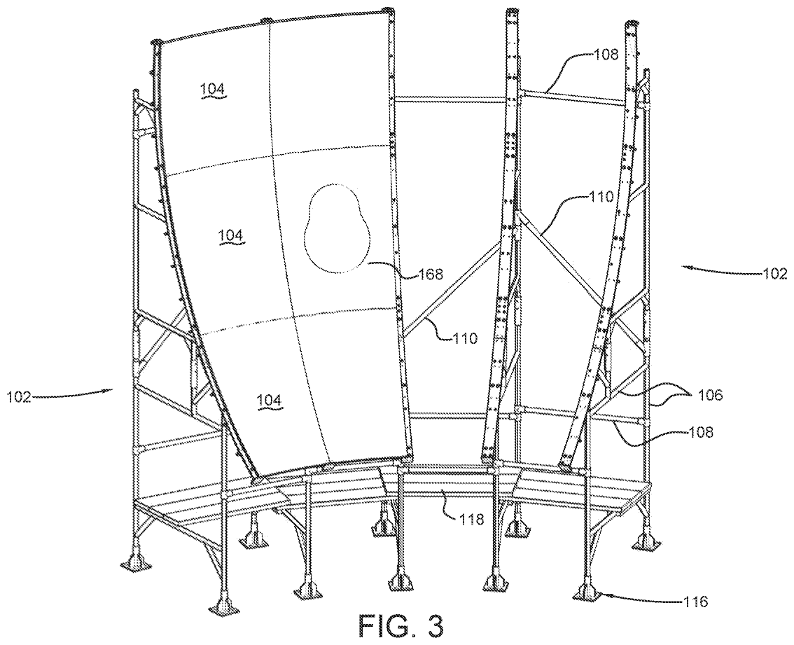

Referring now to FIGS. 1-3, the prefinished curvilinear magnetic screen 100 generally includes a curvilinear structural frame 102, and a plurality of screen panels 104 that are comprised of aerospace grade thermoformable foam sheets. Acoustic panels (e.g., randomized faded perforated panels) 168 may also be used for the screen 100.

The overall geometric shape of the curvilinear projection screen 100 (e.g., compound curve or curvilinear) is typically determined by a “projection study.” The projection study may provide a lens shape, pixel map, lumens, minor radius, major radius, and degrees in plan for a particular application. The particular application could be for a virtual reality type amusement ride, for example. The projection screen 100 may be an up scaled version of the optical characteristics of a lens. There is virtually no limit to size, geometry, shape or orientation in which the projection screen 100 may be orientated to the earth's plane. Most curvilinear projection screens 100 are typically a horizontal/vertical torus (toroidal) or section of a sphere or hemisphere.

The corvilinear structural frame 102 includes a plurality of horizontal and vertical pipe components 106. The horizontal and vertical pipe components may be connected together by truss frame connectors 108 and diagonal truss frame connectors 110. The vertical pipe components 106 are secured to a plurality of bases 116 that rest on a ground surface for support. A plurality of scaffold planks 118 may be temporarily placed over the horizontal pipe components 106 similar to scaffolding in order for the installation technicians to build the structural frame 102 and also to secure screen panels 104 to the structural frame 102.

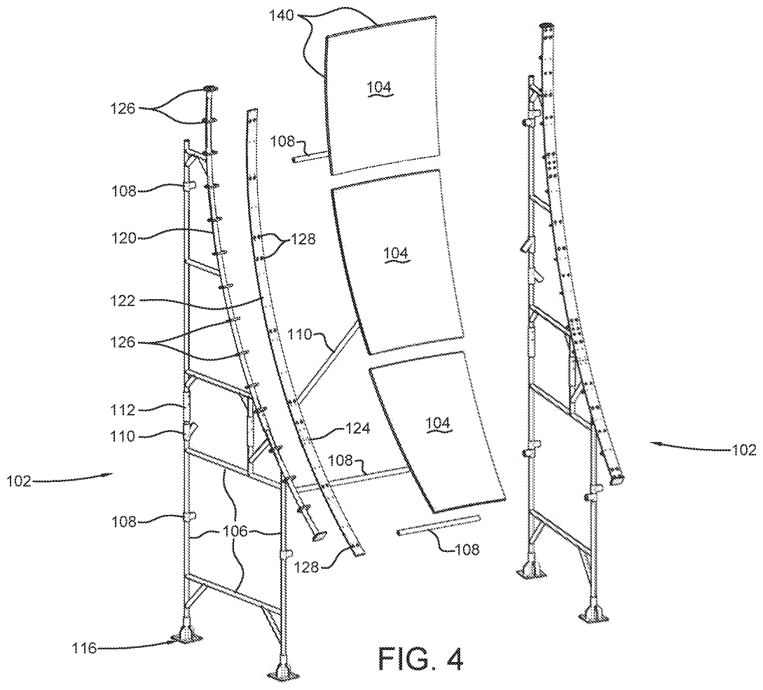

Referring now to FIG. 4, a plurality of rolled tubes 120 are coupled to the horizontal and vertical pipe components 106 to form a plurality of pipe trusses. A plurality of connector sleeves 112 may be used to connect shorter sections of vertical pipe components 106 together.

A plurality of flat bars 122 are coupled to the plurality of rolled tubes 120 by pipe brackets 126. Flat bar connector brackets 124 may be used to connect shorter sections of the flat bar 122 together. The screen panels 104 have tongue and groove joints 140 along their respective edges that help to create a smooth surface on the face side in case panel thickness varies 104. The screen panels 104 are being installed on the plurality of rolled tubes 120. The vertical edges of the screen panels 104 are secured to the plurality of flat bars 122 using magnetic force, where the flat bars 122 are secured to respective rolled tubes 120.

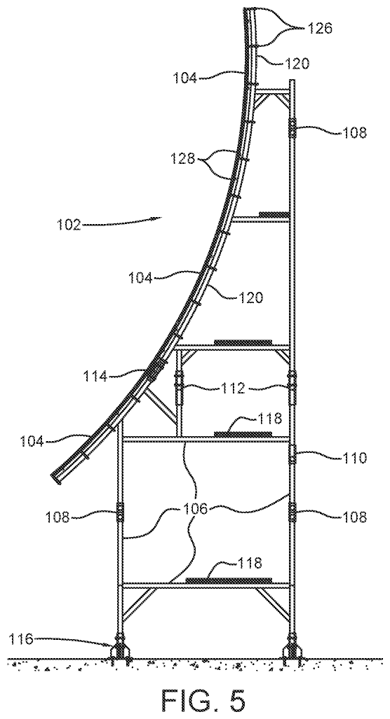

Referring now to FIG. 5, a side elevational view of the screen 100 is shown. As explained above, the structural frame 102 is constructed similar to scaffolding with horizontal and vertical pipe components 106 connected together. The rolled tubes 120 may comprise shorter pieces that are connected together using a pipe connector sleeve 114.

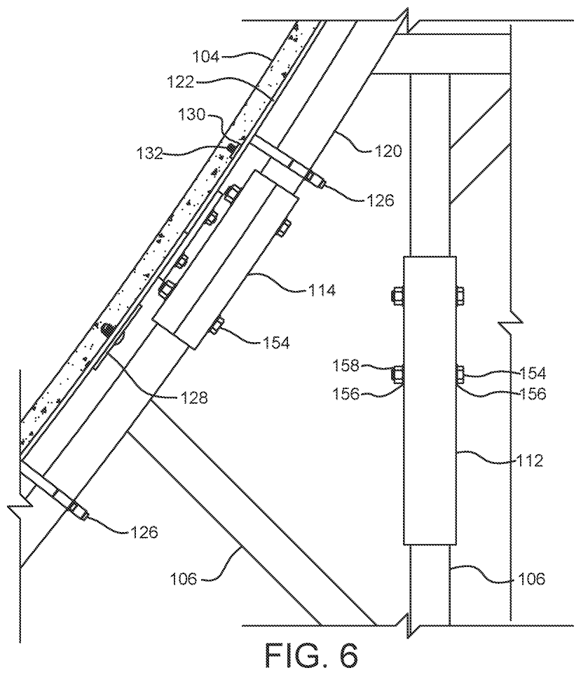

The pipe connector sleeve 114 is shown in detail in FIG. 6. The pipe connector sleeve 114 comprises two opposing elements that are placed over the joint between two pieces of rolled tube 120. The pipe connector sleeve 114 is tightened over the joint using a plurality of bolts 154. Also shown in FIG. 6 is a detail view of connector sleeve 112 used to couple together pieces of vertical tube components 106.

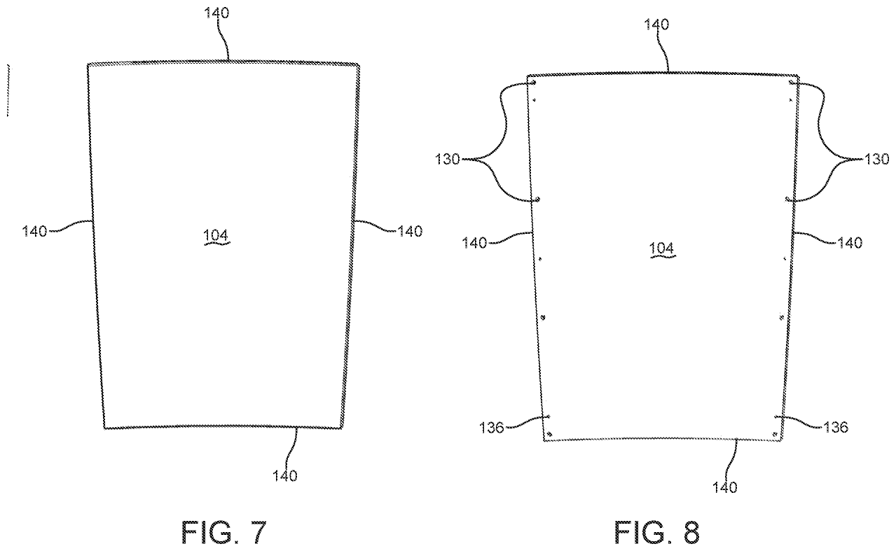

Referring now to FIGS. 7 and 8, front and rear views of an exemplary screen panel 104 are shown with the tongue and groove joints 140 along its edges. The locations of the embedded magnets 130 on the screen panel 104 are also indicated in FIG. 8. In addition, the locations of the tapping inserts 136 are indicated on the rear side of the screen panel 104. The tapping inserts 136 are used to permanently fasten the screen panels 104 to the flat bar 122 as described in more detail below.

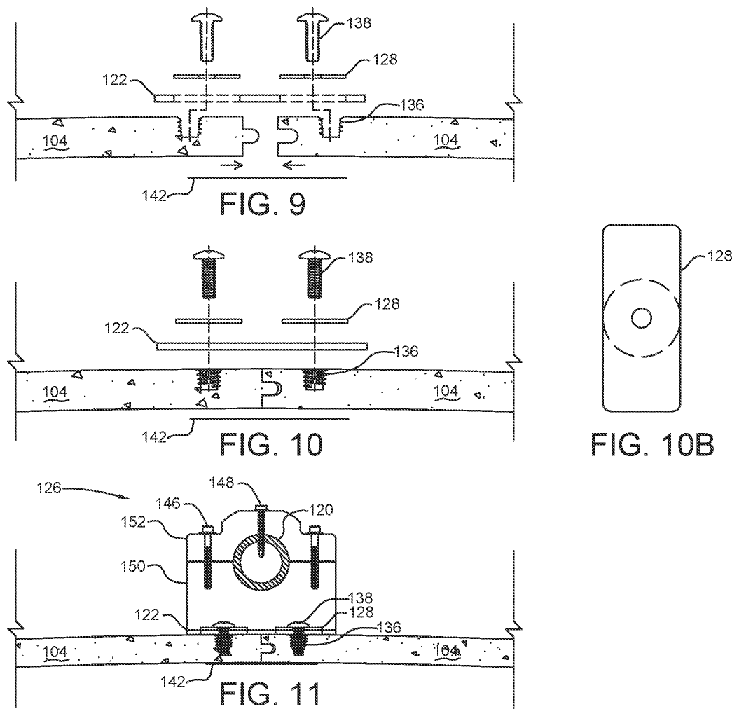

Referring not to FIGS. 9, 10A, and 10B, the screen panels 104 are secured to the flat bar 122 using bolts 138. The flat bar 122 has oversized apertures for the bolts 138 to fit through as best shown in FIG. 17. This allows for the adjustment of the screen panels 104 on the flat bar 122 in order to move the screen panels 104 together to reduce the gap in the joint between adjacent screen panels 104. The bolts 138 are inserted through an oversized washer 128 and through the flat bar 122 into the respective tapping inserts 136.

Referring now to FIG. 11, the screen panel 104 is shown permanently secured to the flat bar 122 using mechanical fasteners, which in a particular aspect are the bolts 138. Also shown in FIG. 11, is pipe bracket 126 securing the rolled tube 120 to the flat bar 122.

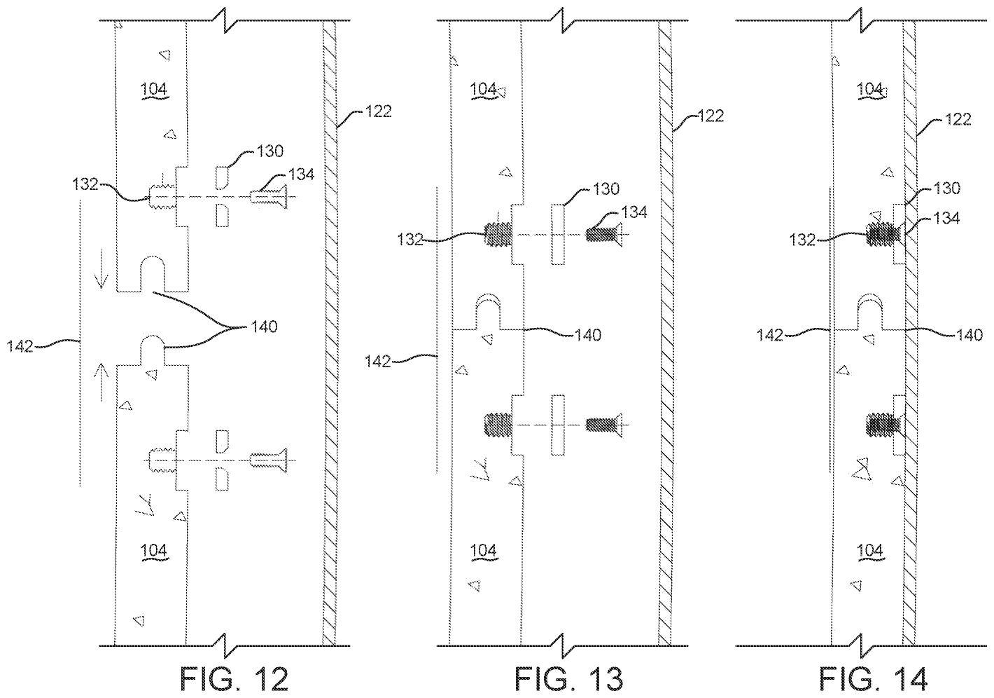

Referring now to FIGS. 12-14, the magnets 130 are embedded within the screen panels 104 using self locking threaded inserts 132. In the rear surface of the screen panels 104 are counterbores that are sized to receive the magnets 130. At the bottom of each counterbore is the threaded insert 132. The magnets 130 include an aperture so that a screw 134 can be used to secure the magnet 130 into the respective counterbore within the rear of the screen panel 104 as shown in FIG. 14.

The pipe bracket 126 is shown in FIGS. 15A and 158 securing the rolled tube 120 to the flat bar 122. The pipe bracket comprises two elements as shown in FIG. 16A that are configured to clamp around the rolled tube 120 and be secured by bolts 146. In addition, machine screws 144 are used to secure the pipe bracket 126 to the flat bar 122. A perspective view of the pipe bracket 126 is shown in FIG. 16B.

Referring now to FIG. 17, an exploded view of the screen panel 104 being secured to the flat bar 122 is illustrated. As discussed above, the flat bar 122 includes oversized apertures that allows for adjustment of the screen panel 104. The tapping insert 136 is positioned initially at the center of the oversized aperture of the flat bar 122. The magnet 130 is positioned on the screen panel 130 proximate the edge and where it will be adjacent to the flat bar 122 so that magnetic forces will temporarily hold the screen panel 104 in place during the adjustment process.

Referring now to FIGS. 18-20, the base 116 of the structural frame 102 is illustrated. The base 116 includes a planar element 166 that is configured to rest flat on a ground surface. A base sleeve 162 is secured to the planar element 166 and extended upwards relative to the ground surface. The base sleeve 162 is configured for the pipe element 106 to slidingly engage. A plurality of flanges 164 may extend perpendicular to the base sleeve 162 to provide additional lateral support. The planar element 166 may be secured to a concrete floor using bolts 160 and the base sleeve 166 is secured to the vertical pipe element 106 using washers 156, bolts 154 and nuts 158.

Acoustic panels 168 may be used with the screen 100 are shown in FIGS. 21-24. The acoustic panels 168 comprise a screen panel 170 having an aperture 178 therein. A randomized faded perforated portion 172 is installed within the aperture. The randomized faded perforated portions 172 may be produced in a mold similar to the screen panels 104 except they are a different material such as carbon fiber or formed aluminum sheet material. The thickness of the randomized faded perforated portions 172 is an important factor to maintain a range between 60-90 thousands in order to keep the structural integrity due to the thousands of holes in the randomized faded perforated portion 172 but keeping the smooth open cell speaker fabric 176 as close to the backside as possible. The speaker fabric 176 and retaining ring 174 are coated with a higher gain projection coating (+2.0, +2.5 gain) than the surface of the main projection screen 100 to brighten the hole cavities in the randomized faded perforated portion 172 due to light loss and darker shadowing effect that occurs prior to higher gain coating.

A method of fabricating the prefinished curvilinear magnetic screen 100 described above begins with generating a three-dimensional model of the screen panels 104 for the desired shape and size of the screen 100. A CNC milling machine may be used to tool a series of positive molds for the screen panels 104 to create the desired surface geometry.

In a particular aspect, aerospace grade thermoformable foam sheets are used to build the screen panels 104. The foam sheets have a dimension of approximately 1 inch thick, and 4 feet wide by 8 feet long. The foam sheets are placed in a custom-built oven for approximately three hours. Once the foam sheets are heated to desired temperature, the manufacturing technician places the foam sheets over the respective positive molds. The foam sheets drape form over the curvilinear shapes of the respective positive molds. After the foam sheets cool to the desired temperature, the foam sheets will retain the shape of the respective positive molds.

The foam sheets now have the desired curvilinear shape and are secured in place via temporary fasteners and alignment pins over the respective positive molds. A CNC router machine may be used to cut the oversized foam sheets to the proper size, machine tongue and groove edge profiles, and drill counter bores for magnets.

The foam sheets are then ready to be primed. A thin skim coat of hard coat filler may be used on the front of foam sheet to achieve a smoother paint finish. The magnets are held in place using a threaded insert that is installed in each counterbore around the perimeter of each of the foam sheets, as described in more detail below.

The foam sheets are then sanded to be smooth to be prepared to receive several projection coating applications. The projection coating is a special screen paint optimized for projection. The foam sheets may be sprayed in the configuration in which they will be installed on the structural framework to help maintain even surface reflectivity. The foam sheets are now finished screen panels and ready to be packaged and shipped.

In a particular aspect, the structural frame comprises 1-2.5 inch diameter steel/aluminum tubing. Rolling round pipe tube is generally more accurate to fabricate the curvilinear geometry than using square or rectangular tubing. This is critical to maintain an accurate screen geometry. A CNC plasma lathe may be used to cut all the components to length and cope all miters to make for quick and easy assembly. The connection points may be welded in a truss jig for accuracy. The leading edge of the truss frame may be rolled tube and custom tube brackets may hold curved flat bar to the rolled tube. The curved flat bar may be steel so that the magnets in the screen panels are attracted as described in more detail below.

Benefits of the prefinished curvilinear magnetic screen system include that it is virtually seamless (high importance), can be a compound curve projection screen, fire rated materials, high resolution, cost effective, installed in dust free zones, durable, maintenance friendly, repairs quickly, allows rear mounted speakers (randomized faded speaker perforated panels), passes seismic load analysis, thermal rated, and sound deadening characteristics.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A prefinished curvilinear magnetic screen system comprising:
a curvilinear structural frame having a front side and a rear side;
a plurality of screen panels adjustably secured to the front side of the curvilinear structural frame using magnetic forces; and
an optical coating over the plurality of screen panels to define a curvilinear projection surface.

2. The system of claim 1, wherein the edges of the plurality of screen panels include interlocking tongue and groove joints.

3. The system of claim 1, wherein the plurality of screen panels have a plurality of magnets embedded proximate edges of the plurality of screen panels and are configured to assist in adjusting a respective position of each of the plurality of panels to the curvilinear structural frame.

4. The system of claim 1, wherein the curvilinear structural frame comprises a plurality of pipe trusses and a plurality of flat bara that are supported by the plurality of pipe trusses.

5. The system of claim 4, wherein the plurality of screen panels are secured to the flat bars.

6. The system of claim 4, wherein the curvilinear structural frame includes a plurality of pipe brackets that each comprise a first portion and a second portion that are configured to clamp around a pipe of the pipe trusses and connect to a respective flat bar.

7. The system of claim 4, further comprising optical seaming tape or optical caulk over joints between the plurality of screen panels.

8. A prefinished curvilinear magnetic screen panel comprising:
a plurality of magnets embedded proximate edges of the screen panel, wherein the plurality of magnets are configured to adjustably secure the screen panel to a curvilinear structural frame; and
an optical coating over the screen panel to define a curvilinear projection surface.

9. The magnetic screen panel of claim 8, wherein the edges of the screen panel include interlocking tongue or groove joints.

10. The magnetic screen panel of claim 8, wherein the plurality of magnets are each secured to the screen panel using a countersunk threaded insert and a bolt engaging the threaded insert to secure a respective magnet to the screen panel.

11. The magnetic screen panel of claim 8, wherein a surface of the screen panel is prefinished to receive an optical coating.

12. A method of fabricating a prefinished curvilinear magnetic screen system, the method comprising:
erecting a curvilinear structural frame having a front side and a rear side;
positioning a plurality of screen panels on to the front side of the curvilinear structural frame, wherein the plurality of screen panels are adjustably secured to the curvilinear structural frame using magnetic forces;
adjusting the plurality of screen panels on the curvilinear structural frame to tighten joints between the plurality of screen panels.

13. The method of claim 12, wherein the plurality of screen panels have a plurality of magnets embedded proximate edges of the screen panel.

14. The method of claim 12, further comprising securing the plurality of panels to the curvilinear structural frame using mechanical fasteners to prevent the plurality of panels from moving.

15. The method of claim 12, further comprising applying an optical caulking or an optical seaming tape over vertical and horizontal joints between the plurality of screen panels.

16. The method of claim 12, further comprising joining edges of the plurality of screen panels together using interlocking tongue and groove joints.

17. The method of claim 12, wherein the curvilinear structural frame comprises a plurality of pipe trusses and a plurality of flat bars that are supported by the plurality of pipe trusses.

18. The method of claim 17, further comprising securing the plurality of screen panels are secured to the flat bars.

19. The method of claim 18, wherein the curvilinear structural frame includes a plurality of pipe brackets that each comprise a first portion and a second portion that are configured to clamp around a pipe of the pipe trusses and connect to a respective flat bar.

20. The method of claim 12, wherein the plurality of screen panels comprises thermoformable material.
